(19) United States
(12) Patent Application Publication
(10) Pub. No.: US 2025/0123822 A1
(43) Pub. Date: Apr. 17, 2025

(54) METHOD, APPARATUS, ELECTRONIC DEVICE, STORAGE MEDIUM AND PRODUCT FOR PROCESSING A COMPONENT

(71) Applicant: Beijing Zitiao Network Technology Co., Ltd., Beijing (CN)

(72) Inventors: Chenyang Mao, Beijing (CN); Zhengzhe Zhang, Beijing (CN); Junhui Gao, Beijing (CN); Xuebin Yang, Beijing (CN); Yiping Zheng, Beijing (CN); Haohui Ou, Beijing (CN); Changyu Guo, Beijing (CN); Zihua Wu, Beijing (CN); Jinjie Zhang, Beijing (CN); Wenhao Qiu, Beijing (CN)

(21) Appl. No.: 18/573,987

(22) PCT Filed: Aug. 30, 2022
(86) PCT No.: PCT/CN2022/115757

§ 371 Date: Dec. 22, 2023

(30) Foreign Application Priority Data
Sep. 1, 2021 (CN) 202111022607.6

(51) Int. Cl. G06F 8/40

(52) U.S. Cl. CPC G06F 8/40

(57) ABSTRACT

The disclosure relates to a method, apparatus, electronic device, storage medium and product for processing a component, including: sending a block information entity request to a target platform, the block information entity request including a block identifier corresponding to a target component; receiving a block information entity corresponding to the target component sent by the target platform; and invoking a component software development kit to render the target component in a document based on the block information entity, which achieves a corresponding function in the form of a component in a document by rendering and running the target component sent by the target platform through the component software development kit and improves the diversity of document functions. Different requirements of users can be met.

### CROSS REFERENCE

The present application claims priority to Chinese Patent Application No. 202111022607.6, filed on Sep. 1, 2021, and entitled “METHOD, APPARATUS, ELECTRONIC DEVICE, STORAGE MEDIUM AND PRODUCT FOR PROCESSING A COMPONENT”, the contents of which are hereby incorporated by reference in its entirely.

### FIELD

The present disclosure relates to the field of computer technologies, and in particular to a method, apparatus, electronic device, storage medium, and product for processing a component.

### BACKGROUND

With the popularity of electronic offices, users have higher requirements for electronic offices, and need applications that can be applied to various functions. Sometimes, various functions need to be implemented simultaneously in a same application, such as a plurality of functions in documents.

Related technologies rely on developers to implement various functions in a same application. However, different users may have different requirements for functions.

The use of the related technologies cannot meet diverse needs of the users.

### SUMMARY

In order to solve the above technical problems, the present disclosure provides a method, apparatus, electronic device, storage medium and product for processing a component. The method, apparatus, electronic device, storage medium and product for processing a component realizes a corresponding function in the form of a component in a document and improves the diversity of document functions, which can meet different needs of users to satisfy user requirements.

In a first aspect, the present disclosure provides a method for processing a component, comprising:
sending a block information entity request to a target platform, the block information entity request comprising a block identifier corresponding to a target component;
receiving a block information entity corresponding to the target component sent by the target platform; and
invoking a component software development kit to render the target component in a document based on the block information entity.

In a second aspect, embodiments of the present disclosure provide a further method for processing a component, comprising:
in response to receiving a trigger operation on a first target control in a document page, displaying a component panel, the component panel comprising at least one target component, and the first target control having a one-to-one correspondence with a content line in the document page; and
in response to a selection operation on the target component, displaying component content corresponding to the target component in a content line associated with the first target control in the document page.

In a third aspect, embodiments of the present disclosure provide an apparatus for processing a component, comprising:
a request sending module configured to send a block information entity request to a target platform, the block information entity request comprising a block identifier corresponding to a target component;
a receiving module configured to receive a block information entity corresponding to the target component sent by the target platform; and
a target component rendering module configured to invoke a component software development kit to render the target component in a document based on the block information entity.

In a fourth aspect, embodiments of the present disclosure provide a further apparatus for processing a component, comprising:
a component panel display module configured to display a component panel in response to receiving a trigger operation on a first target control in a document page, the component panel comprising at least one target component, and the first target control having an one-to-one correspondence with a content line in the document page; and
a component content display module configured to display, in response to a selection operation on the target component, component content corresponding to the target component in a content line associated with the first target control in the document page.

In a fifth aspect, embodiments of the present disclosure provide an electronic device, comprising:
one or more processors; and
a storage device for storing one or more programs which, when executed by the one or more processors, cause the one or more processors to implement the method of any of the first aspect.

In a sixth aspect, embodiments of the present disclosure provide a computer-readable storage medium having a computer program stored thereon, characterized in that the program, when executed by a processor, implements the method of any of the first aspect or the second aspect.

In a seventh aspect, embodiments of the present disclosure provide a computer program product, when executed on a computer, causes the computer to perform the steps of the method according to any of the first aspect or the second aspect.

The technical solution provided by the embodiments of the present disclosure has the following advantages compared with the prior art:
the method, apparatus, electronic device, storage medium and product for processing a component provided in the present disclosure can achieve rendering and running a component in a document, by sending a block information entity request to a target platform, the block information entity request comprising a block identifier corresponding to a target component; receiving a block information entity corresponding to the target component sent by the target platform; invoking a component software development kit to render the target component in a document based on the block information entity; and rendering and running the target component sent by the target platform through the component software development kit. That is, a corresponding function can be realized in the form of the component in the document, which improves the diversity of document functions and can meet the different user requirements.

### BRIEF DESCRIPTION OF DRAWINGS

The drawings herein are incorporated in and constitute a part of this specification, illustrating embodiments consistent with the present disclosure and explaining the principles of the present disclosure together with the description.

In order to more clearly illustrate the technical solutions in the embodiments of the present disclosure or prior art, the following will briefly introduce the drawings that need to be used in the description of the embodiments or prior art. Apparently, those of ordinary skilled in the art can obtain other drawings based on these drawings without creative labor.

FIG. 1 is a schematic flow diagram of a method for processing a component provided in embodiments of the present disclosure;

FIG. 2 is an interaction schematic diagram of a method for processing a component provided in embodiments of the present disclosure;

FIG. 3 is a schematic diagram of a BlockitSDK implementation structure provided in embodiments of the present disclosure;

FIG. 4 is a schematic diagram of an interface structure of a method for processing a component provided in embodiments of the present disclosure

FIG. 5 is a flowchart of a further method for processing a component provided in embodiments of the present disclosure;

FIG. 6 is a schematic diagram of an interface structure of a method for processing a component provided in embodiments of the present disclosure;

FIG. 7 is a flow diagram of a still further method for processing a component provided in embodiments of the present disclosure;

FIG. 8 is a schematic diagram of an interface structure of a further method for processing a component provided in embodiments of the present disclosure;

FIG. 9 is an interaction schematic diagram of a further method for processing a component provided in embodiments of the present disclosure;

FIG. 10 is a schematic flow diagram of a yet further method for processing a component provided in embodiments of the present disclosure;

FIG. 11 is an interaction schematic diagram of a yet further method for processing a component provided in embodiments of the present disclosure;

FIG. 12 is a flowchart of a yet further method for processing a component provided in embodiments of the present disclosure;

FIG. 13 is an interaction schematic diagram of a yet further method for processing a component provided in embodiments of the present disclosure;

FIG. 14 is an interaction schematic diagram of a yet further method for processing a component provided in embodiments of the present disclosure;

FIG. 15 is an interaction schematic diagram of a yet further method for processing a component provided in embodiments of the present disclosure;

FIG. 16 is an interaction schematic diagram of a yet further method for processing a component provided in embodiments of the present disclosure;

FIG. 17 is an interaction schematic diagram of a yet further method for processing a component provided in embodiments of the present disclosure;

FIG. 18 is an interaction schematic diagram of a yet further method for processing a component provided in embodiments of the present disclosure;

FIG. 19 is a schematic diagram of a structure of an apparatus for processing a component provided in embodiments of the present disclosure;

FIG. 20 is a schematic diagram of a structure of a further apparatus for processing a component provided in embodiments of the present disclosure;

FIG. 21 is a schematic diagram of a structure of an electronic device provided in embodiments of the present disclosure of the disclosure.

### DETAILED DESCRIPTION

In order to more clearly understand the above objects, features and advantages of the present disclosure, technical solutions of the present disclosure will be further described in the following. In should be noted that embodiments of the present disclosure and features in the embodiments may be combined with each other without conflict.

Many specific details are set forth in the following description in order to fully understand the present disclosure, but the present disclosure may also be implemented in ways different from that described herein. Apparently, the embodiments in the description are only part of the present disclosure, rather than all the embodiments of the present disclosure.

For example, the present disclosure provides a method, apparatus, electronic device, computer storage medium and computer program product for processing a component, which supports a user to develop and implement an application and integrate the application into a document by himself/herself in a use context of the document. That is, by developing a document widget, the user can freely insert, edit, and read the document component developed by himself/herself in the document, just like using a function provided by the official. The document component is developed based on a component software development kit, which does not require much effort to handle collaborative logic and enables the component to support collaborative editing by a plurality of people.

The method for processing a component disclosed herein is performed by an electronic device or an application program, a webpage, a subscription account, or the like in the electronic device. The electronic device may be a tablet computer, a mobile phone, a wearable device, a vehicle-mounted device, an augmented reality (AR)/virtual reality (VR) device, a laptop computer, an ultra-mobile personal computer (UMPC), a netbook, a personal digital assistant (PDA), a smart TV, a smart screen, a high-definition TV, a 4K TV, a smart speaker, a smart projector, and so on. The present disclosure does not limit the specific type of the electronic device.

The present disclosure herein does not limit the type of the operating system of the electronic device, for example, Android system, Linux system, Windows system, iOS system, etc.

The technical solutions of the present disclosure will be described in detail in the following several specific embodiments.

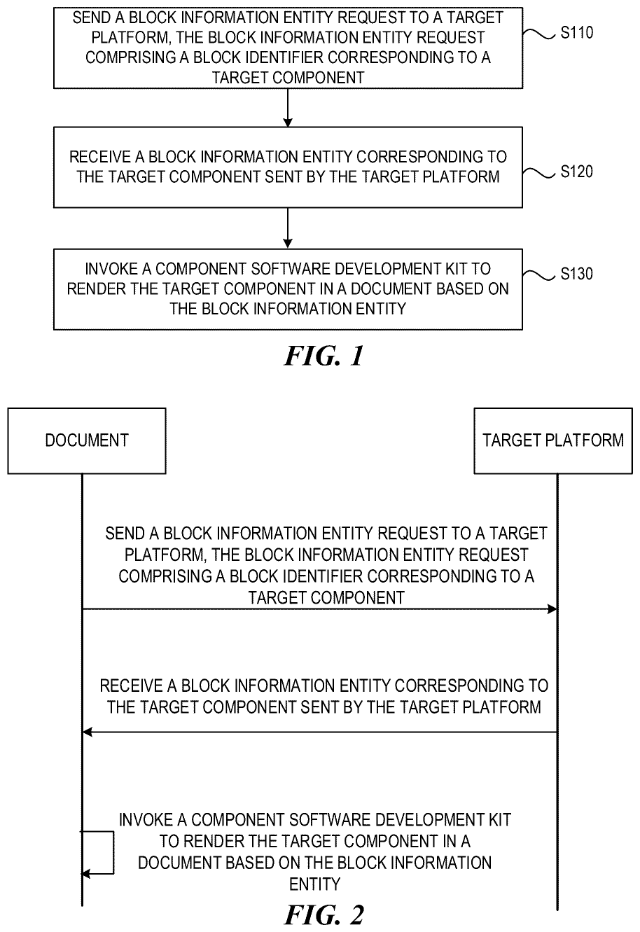

FIG. 1 is a schematic flow diagram of a method for processing a component provided in embodiments of the present disclosure. As shown in FIG. 1, the method of the embodiments of the present disclosure is as follows:

S110: sending a block information entity request to a target platform, the block information entity request comprising a block identifier corresponding to a target component.

For example, a component such as instant messaging communication, a timer, a workbench, and a calendar can be inserted into a document. That is, the component such as instant messaging, a timer, a workbench, and a calendar is block information entity in the document, that is, a Block. The block information entity request can include inserting a part of a chat history from the instant messaging in the document, inserting a timer in the document to achieve a timing function, inserting a schedule in a calendar in the document, inserting a paragraph in the document, etc. When the user inserts a timer in the document to achieve a timing function, the document sends a block information entity request to establish a timer in the document to the target platform. The target component in the block information entity request is a timer, and the block identifier corresponding to the target component is a block identifier corresponding to a timer. For example, the block identifier corresponding to the timer is Block ID1.

Specifically, the block information entity is created by a Creator. After creating the block information entity, the block information entity request is sent to the target platform.

Since all sub-products in a certain book are composed of information entities of the certain book, a certain information entity in Product A can be forwarded to Product B. For example, a message can be forwarded to a document, or a schedule can be forwarded to an instant messaging, and so on.

In some embodiments of the present disclosure, the target platform may be a certain mobile terminal, a certain application program, a certain cloud service platform or a certain server.

S120: receiving a block information entity corresponding to the target component sent by the target platform.

After the document sends the block information entity request to the target platform, the document submits block information entity request data to the target platform, and the target platform stores the data and sends the block information entity corresponding to the target component.

For example, when the block information entity request is sent to the target platform with the timer inserted in the document as the block information entity and a countdown information of the timer being “2 days 0 hours 0 minutes 0 seconds”, the target platform determines that the block information entity request is to insert the timer into the document and the countdown information of the timer is “2 days 0 hours 0 minutes 0 seconds” based on the received block information entity request. At this time, the block information entity corresponding to the target component is determined based on the block information entity request, that is, the target component is the timer, and the block information entity corresponding to the target component is the timer that displays the countdown information “2 days 0 hours 0 minutes 0 seconds”.

S130: invoking a component software development kit to render the target component in a document based on the block information entity.

The method for processing a component provided in the embodiments of the present disclosure is based on the component software development kit (BlockitSDK), wherein the BlockitSDK provides an application data model, application mechanism management, application rendering engine and application flow protocol.

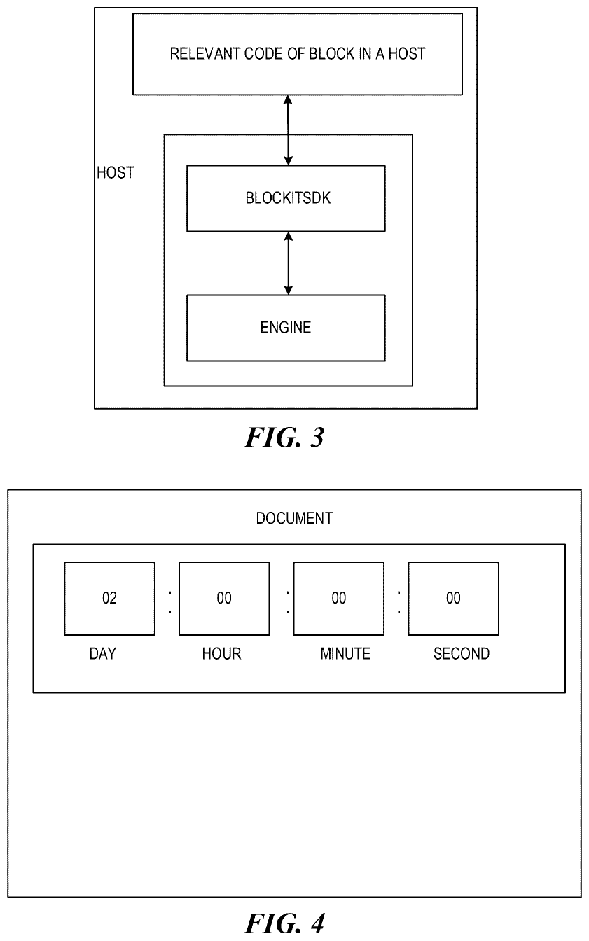

When the timer in the document receives the block information entity corresponding to the target component sent by the target platform, the BlockitSDK is invoked. At this time, the BlockitSDK renders the target component in the document based on the block information entity. As shown in FIG. 3, the BlockitSDK is invoked to render a target component timer, and a rendering effect is a countdown from 2 days 0 hours 0 minutes 0 seconds. Specifically, a service encapsulation is performed by a Blockit Module in the document based on the BlockitSDK and provided to an ISV Block component of the document for use. The ISV Block records information of the target component in document data, and then the ISV Block component invokes the Blockit Block to render the target component based on the information of the target component.

In a front-end rendering engine of the BlockitSDK, a dual-thread engine similar to a mini program is used to handle rendering and logic respectively. In the rendering part, a shadowDOM technology is used as a UI sandbox, embedded into a host and becomes part of the host's content without affecting the display of the host's own content. In the logic part, the browser's built-in sandbox environment, Worker, is used to perform logical operations. The relationship between the host, BlockitSDK, and engine is shown in FIG. 4.

After the engine starts, a sandbox environment that is not aware of the external environment is established. APIs and a collection of components are provided in this environment. After a developer use DSL to develop and package, a same effect can be presented even under different hosts.

The method for processing a component provided in the embodiments of the present disclosure can achieve rendering and running a component in a document, by sending a block information entity request to a target platform, the block information entity request comprising a block identifier corresponding to a target component; receiving a block information entity corresponding to the target component sent by the target platform; and invoking a BlockitSDK to render the target component in a document based on the block information entity. That is, a corresponding function can be realized in the form of the component in the document, which improves the diversity of document functions and can meet the different user requirements.

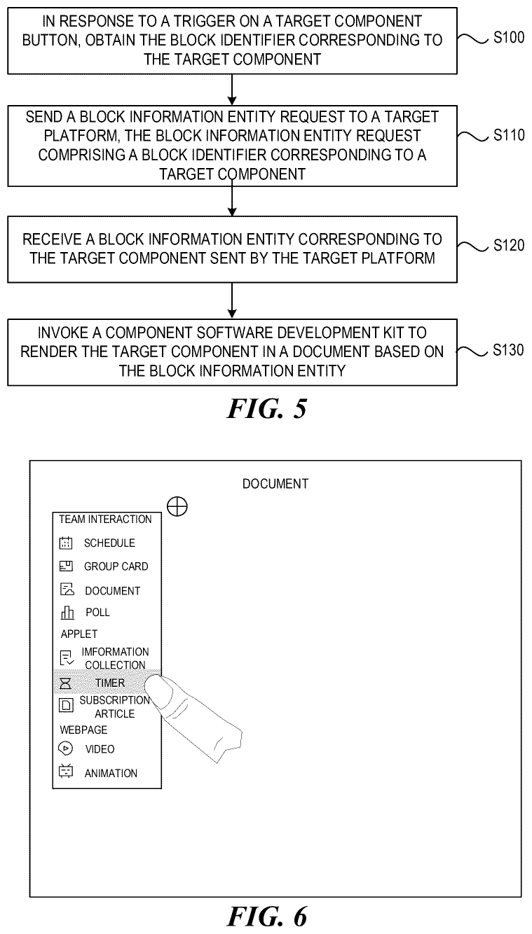

FIG. 5 is a flowchart of a further method for processing a component provided in embodiments of the present disclosure, which are on the basis of the above embodiments. As shown in FIG. 5, before step S110, the method further comprises:

S100: in response to a trigger on a target component button, obtaining the block identifier corresponding to the target component.

When the user triggers the target component button in the document, specifically, the user triggers a timer button in the document as shown in FIG. 6, the timer button is the target component at this point. Based on the target component button triggered by the user, the block identifier of the target component is determined. For example, the obtained block identifier corresponding to the timer is Block ID1; the obtained block identifier corresponding to the workbench is Block ID2; and the obtained block identifier corresponding to the calendar is Block ID3, different target components corresponding to different block identifiers.

The method for processing a component provided in the embodiments of the present disclosure, before sending the block information entity request to the target platform, in response to the trigger on the target component button, obtains the block identifier corresponding to the target component, and then based on the block identifier corresponding to the target component, determines the target component for which the block information entity request is sent to the target platform.

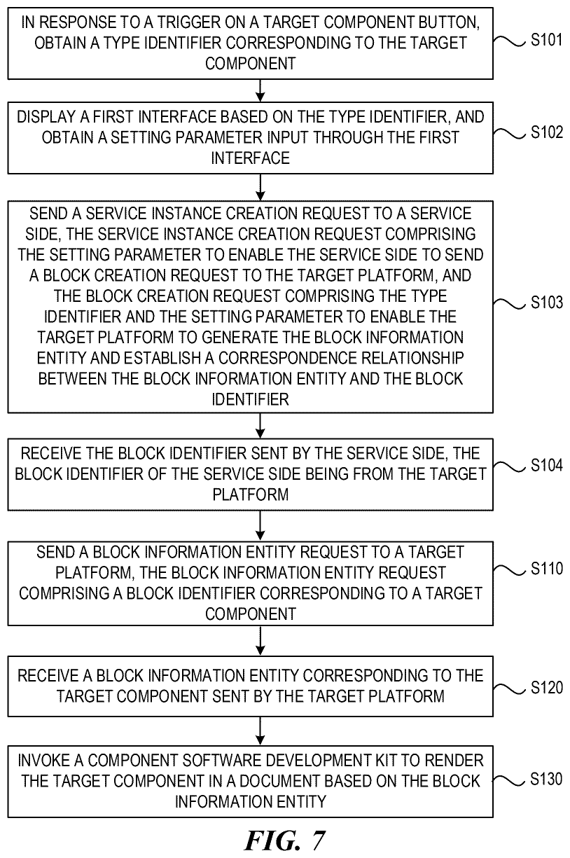

FIG. 7 is a flow diagram of a still further method for processing a component provided in embodiments of the present disclosure, which are on the basis of the embodiments corresponding to FIG. 5. As shown in FIG. 7, an implementation of step S100 comprises:

S101: in response to a trigger on a target component button, obtaining a type identifier corresponding to the target component.

When the user triggers the target component button in the document, specifically, the user triggers the timer button in the document, the timer button is the target component at this point. The type identifier corresponding to the target component is obtained, that is, the type identifier corresponding to the timer button is obtained. For example, the type identifier of the timer button is Block Type ID1; the type identifier of the workbench is Block Type ID2; and the type identifier of the calendar is Block Type ID3, different target components corresponding to different type identifiers.

S102: displaying a first interface based on the type identifier, and obtaining a setting parameter input through the first interface.

After the trigger on the target component, the target component is displayed in the document, and the first interface is displayed based on the type identifier corresponding to the target component. For example, when the target component is a timer, the first interface displayed based on the type identifier corresponding to the timer is shown in FIG. 8 at this point. After the user sets a parameter of the timer on the first interface, the block information entity obtains the setting parameters input through the first interface. For example, when the user sets the parameter of the timer in the first interface as “countdown duration is 2 days 0 hours 0 minutes 0 seconds”, the obtained setting parameter is “countdown duration is 2 days 0 hours 0 minutes 0 seconds” at this time.

S103: sending a service instance creation request to a service side, the service instance creation request comprising the setting parameter to enable the service side to send a block creation request to the target platform, and the block creation request comprising the type identifier and the setting parameter to enable the target platform to generate the block information entity and establish a correspondence relationship between the block information entity and the block identifier.

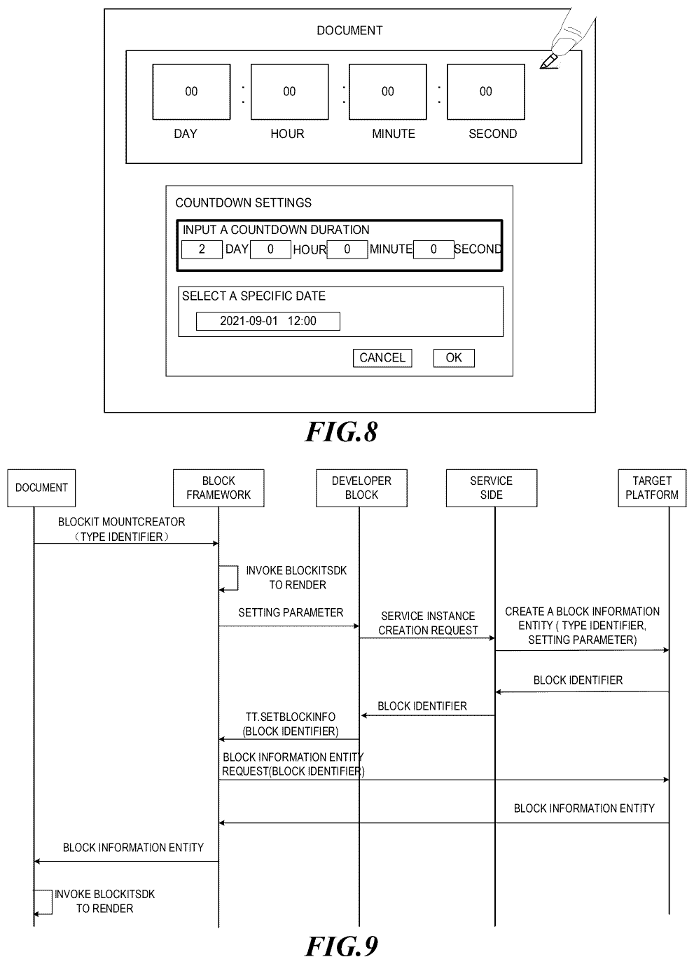

After the document obtains the parameter input in the first interface of the block information entity, the service instance creation request is sent to the service side, to enable the service side to send a block creation request to the target platform. Specifically, as shown in FIG. 9, the document first invokes a Blockit.mountCreator (Block Type ID1), that is, the document invokes the Blockit.mountCreator to construct the block information entity with the type identifier of Block Type ID1 to be displayed in the document. The setting parameter obtained through the first interface is issued to a developer Block by a Block framework, and the service instance creation request is issued to the service side based on the setting parameters by the developer Block. The service side executes a service creation logic and invokes a target platform API to create the block information entity, that is, the developer Block declares to the service side to create the corresponding block information entity. For example, to construct the timer block information entity in the document, the document first invokes the Blockit.mountCreator command to construct the timer block information entity in the document. When the setting parameter in the timer block information entity constructed in the document is “countdown duration is 2 days 0 hours 0 minutes 0 seconds”, the Block framework issues the setting parameters in the constructed timer block information entity to the developer Block. The developer Block sends a service instance request to the service side based on the setting parameters in the constructed timer block information entity—that is, the developer Block sends a request to create a timer with a countdown information of 2 days 0 hours 0 minutes 0 seconds to the service side. At this time, the created service instance is the timer with the countdown information of 2 days 0 hours 0 minutes 0 seconds. At this time, the service side sends the block creation request to the target platform, the block creation request including the type identifier and the setting parameter. At this time, the type identifier is Block Type ID1, and the setting parameter is countdown 2 days 0 hours 0 minutes 0 seconds.

After the service side sends the block creation request to the target platform, the target platform generates a corresponding relationship between the block information entity and the block identifier. In other words, the target platform generates and establishes a timer block information entity, and establishes a corresponding relationship between the block information entity and the block identifier Block ID, that is, the target platform establishes a block information entity with a countdown from 2 days 0 hours 0 minutes 0 seconds, which corresponds to the block identifier Block ID1.

S104: receiving the block identifier sent by the service side, the block identifier of the service side being from the target platform.

After the target platform generates the block information entity, the block identifier, Block ID1, corresponding to the block entity is sent to the service side. The service side sends the block identifier to the developer Block, and the developer Block invokes a tt.setBlockInfo to input the block identifier to the Block framework. It should be noted that before invoking the tt.setBlockInfo, a service side interface needs to be invoked and relevant data needs to be transferred.

After the developer Block sends the block identifier to the Block framework, the Block framework obtains the block information entity based on the block identifier, and the target platform returns the block information entity obtained by the Block framework based on the block identifier to the Block framework (that is, obtains a BlockEntity based on the Block ID1). The Block framework returns the block information entity to the document, completing the creation of the block information entity in the document. When the timer in the document receives the block information entity corresponding to the target component sent by the target platform, the Block framework invokes the BlockitSDK target platform. At this time, the BlockitSDK target platform renders the target component in the document based on the block information entity. Specifically, the service encapsulation is performed by the Blockit Module in the document based on the BlockitSDK and provided to the ISV Block component of the document for use. The ISV Block records the information of the target component in the document data, and then the ISV Block component invokes the Blockit Block to render the target component based on the information of the target component.

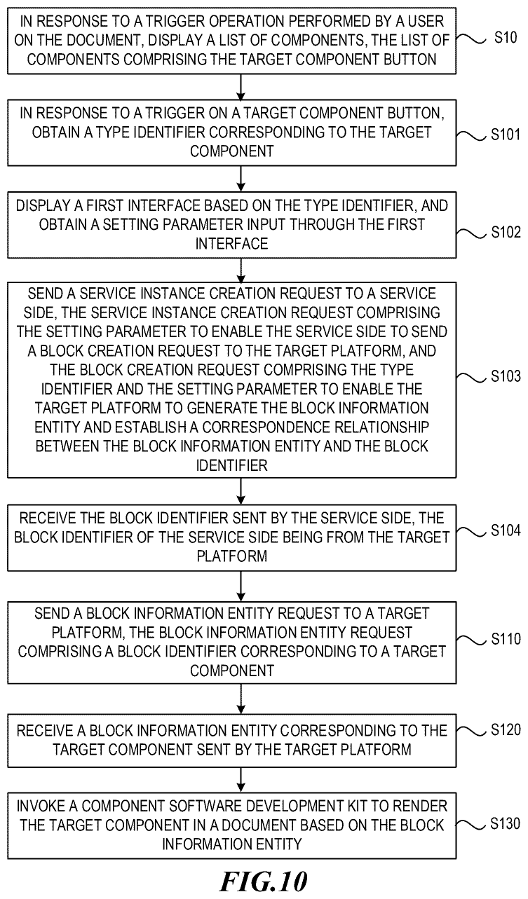

FIG. 10 is a schematic flow diagram of a yet further method for processing a component provided in embodiments of the present disclosure, which are on the basis of the above embodiment. As shown in FIG. 10, before step S101, the method further comprises:

S10, in response to a trigger operation performed by a user on the document, displaying a list of components, the list of components comprising the target component button.

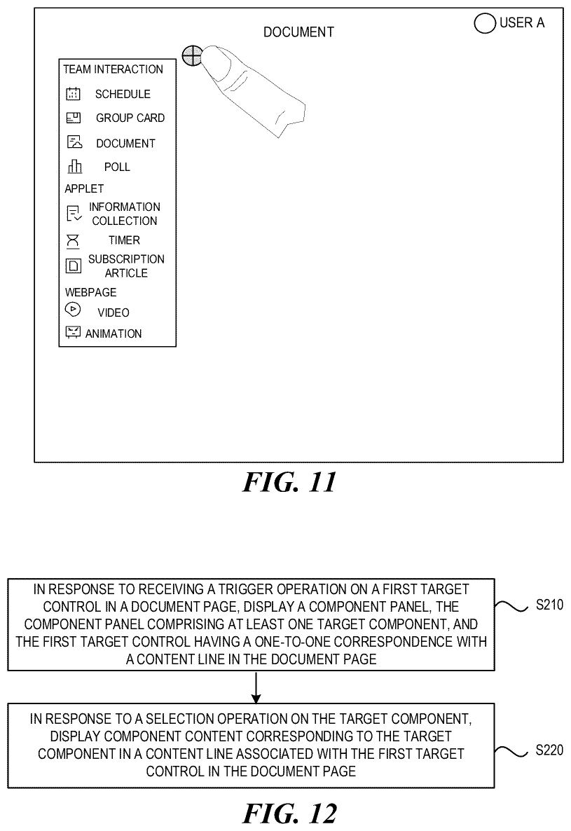

For example, as shown in FIG. 11, when the user clicks a “+” button on the document, the trigger operation performed by the user on the document is clicking the “+” button, and the list of components is displayed in response to the trigger operation performed by the user on the document. That is, after the user clicks the “+” button on the document, the list of components is displayed in the document, and the list of components includes the target component button.

It should be noted that clicking the “+” button on the document and displaying the list of components in FIG. 11 are for the purpose of illustration. In other implementations, the trigger operation may be in other ways, and the embodiments of the present disclosure don't limit the specific type of the triggering operation.

Specifically, in response to the trigger operation performed by the user on the document, based on a permission of the user, an available component corresponding to the user is obtained, and the list of components is displayed, the list of components including the available component corresponding to the user.

Due to different usage permissions to the target component in the document configured by different users, after the user performs a triggering operation, the available components for the user are displayed based on the permission of the user. For example, if the permission of User A to use the target component in the document are set to include information collection, timer, and subscription article components in the applet, when the user clicks the “+” button on the document, the triggering operation performed by the user on the document is clicking the “+” button, and in response to the triggering operation performed by the user on the document, the list of components is displayed. The applet includes information collection, timer, and subscription article components, and information collection, timer, and subscription article components included in the applet can be triggered by clicking.

In response to the trigger operation performed by the user on the document and based on the permission of the user, the method for processing a component provided in the embodiments of the present disclosure obtains the available component corresponding to the user and displays the list of components that includes the available component corresponding to the user, to make the component available to the user to be displayed based on the permission of the user.

It should be noted that, in the method for processing a component provided in the above embodiment, taking a document as the host for the target component is for the purpose of illustration. In other implementations, the host for the target component may be other application terminals, and the embodiments of the present disclosure don't limit the host for the target component specifically.

FIG. 12 is a flowchart of a yet further method for processing a component provided in embodiments of the present disclosure. As shown in FIG. 12, the method for processing a component comprises:

S210: in response to receiving a trigger operation on a first target control in a document page, displaying a component panel, the component panel comprising at least one target component, and the first target control having a one-to-one correspondence with a content line in the document page.

In some embodiments of the present disclosure, the document page includes a plurality of content lines. Each content line corresponding to a respective target control, through which the content line is edited or content associated with the content line is edited.

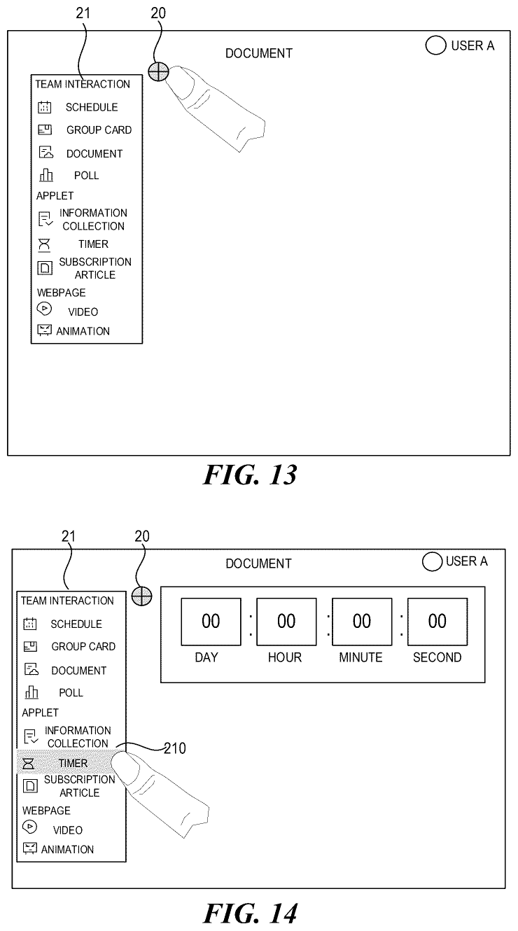

For example, as shown in FIG. 13, when the user triggers a first target control 20 in the document page, a component panel 21 including at least one target component is displayed in the document page. Target components included in the component panel 21 are schedule, group card, document, poll, information collection, timer, subscription article, video, and animation components.

By setting the first target control 20 in the document page to correspond one-to-one with a content line in the document page, by clicking the first target control 20 at a corresponding content line position in the document page, the target components that can be inserted into the component panel 21 at the corresponding content line position are displayed.

S220: in response to a selection operation on the target component, displaying component content corresponding to the target component in a content line associated with the first target control in the document page.

After the user triggers the first target control 20 in the document page to display the component panel 21 in the document page, if the user selects and triggers a target component 210, for example, the user selects and triggers a timer component, the component content corresponding to the target component is displayed in the content line associated with the first target control 20 in the document page, as shown in FIG. 14.

Optionally, the method further includes:
in response to a focus selection of an empty content line in the document page, displaying the first target control at a position associated with the empty content line.

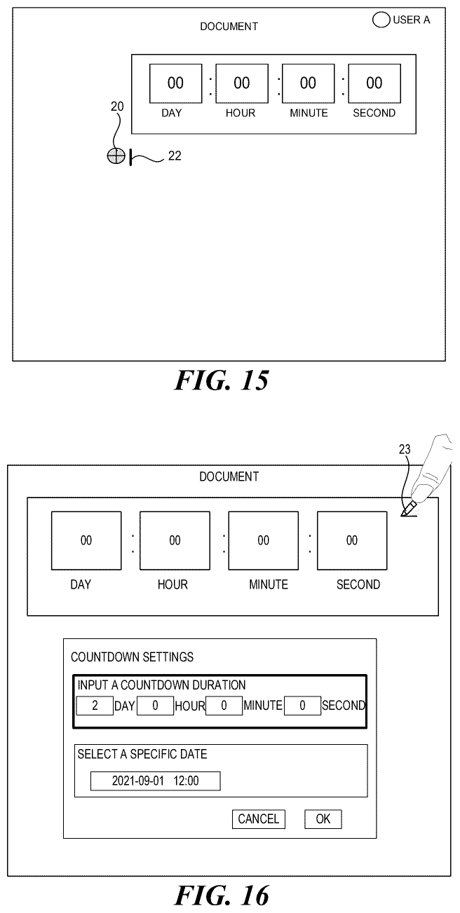

For example, as shown in FIG. 15, after the user inserts the target component in the first empty content line of the document page, the user's mouse focus 22 selects the second empty content line in the document page, and the first target control 20 is displayed at the associated position of the second empty content line.

Optionally, the method further includes:
in response to a focus selection of a non-empty content line in the document page, displaying a second target control at a position associated with the non-empty content line, the second target control being used to edit content in the content line.

In some embodiments of the present disclosure, after the user inserts content in the empty content line, the first target control is switched into a second target control. The second target control generates a corresponding edit option based on the inserted content, and the user can edit the inserted content by selecting the edit option.

For example, as shown in FIG. 16, after the user inserts the target component in the first empty content line of the document page, the user's mouse focus 22 selects the first content line in the document page, which is a non-empty content line at this time. At this time, in response to the user's mouse focus selects the first content line, the second target control 23 is displayed at the associated position of the non-empty content line, enabling the user to edit the content of the content line by triggering the second target control. As shown in FIG. 16, the user moves the mouse focus to the second target control 23 to trigger the second target control 23, and edits the content of the content line. FIG. 16 shows illustratively that after triggering the second target control 23, the countdown function is implemented in the document page by editing the countdown duration of the content line.

Optionally, the displaying component content corresponding to the target component in a content line associated with the first target control in the document page comprises:
displaying the component content corresponding to the target component in a line adjacent to the content line corresponding to the first target control; or displaying the component content corresponding to the target component in the content line corresponding to the first target control.

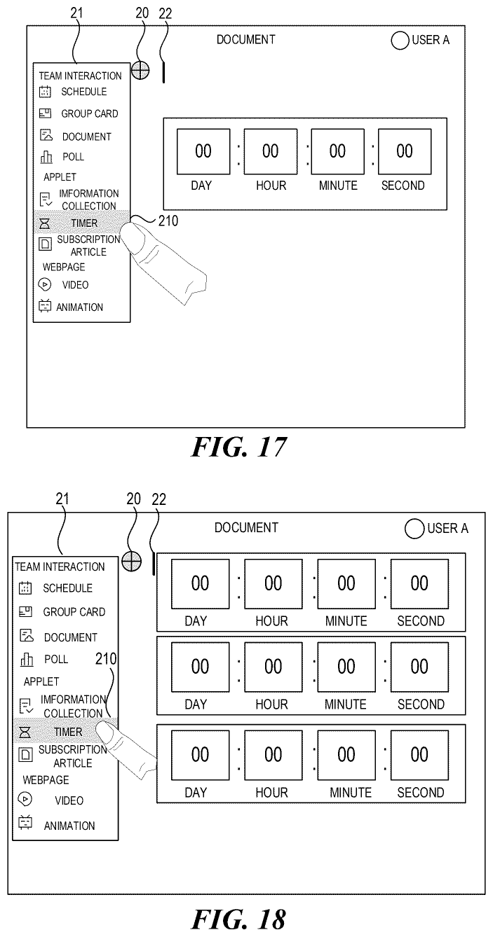

FIG. 14 shows illustratively that the component content corresponding to the target component 210 is displayed in the content line corresponding to the first target control 20. In a further embodiment, the component content corresponding to the target component can be displayed in the line adjacent to the content line corresponding to the first target control 20. See FIG. 17, the content line corresponding to the first target control 20 is at the position of the focus 22 in FIG. 17. When the user selects the target component 210 in the component panel, the component content corresponding to the target component 210 is displayed in the line adjacent to the content line corresponding to the first target control 20, that is, the component content corresponding to the target component 210 is displayed in the line adjacent to the focus 22.

Optionally, the method further includes:
expanding a range of the content line corresponding to the first target control, and displaying the component content corresponding to the target component in the expanded content line.

In a further possible implementation, by expanding the range of the content line corresponding to the first target control 20, when the user selects the target component 210 in the component panel, the component content corresponding to the target component is displayed in the expanded content line. For example, as shown in FIG. 18, the content line corresponding to the first target control 20 is expanded to a range of the content lines corresponding to the position of the focus 22 and the two lines below the line of the focus 22. After the user selects the target component 210 in the component panel, the component content corresponding to the target component 210 is displayed in the line of the focus 22 line and the two lines below the line of the focus 22.

Optionally, the method further includes:
associating the component content corresponding to the target component with the content line to generate a component block, the component block being editable as a whole.

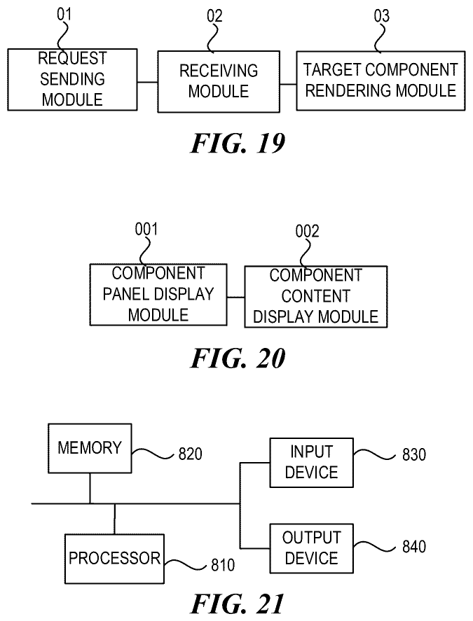

FIG. 19 is a schematic diagram of a structure of an apparatus for processing a component provided in embodiments of the present disclosure, which are on the basis of above embodiments. As shown in FIG. 19, the apparatus for processing a component comprises:
a request sending module 01 configured to send a block information entity request to a target platform, the block information entity request comprising a block identifier corresponding to a target component; a receiving module 02 configured to receive a block information entity corresponding to the target component sent by the target platform; and a target component rendering module 03 configured to invoke a component software development kit to render the target component in a document based on the block information entity.

In the apparatus for processing a component provided in the embodiments of the present disclosure, the request sending module sends a block information entity request to a target platform, the block information entity request comprising a block identifier corresponding to a target component; the receiving module receives a block information entity corresponding to the target component sent by the target platform; and the target component rendering module invokes a component software development kit to render the target component in a document based on the block information entity, to achieve rendering and running the component in the document.

Optionally, the apparatus for processing a component further comprises a block identifier obtaining module configured to respond to obtain the block identifier corresponding to the target component in response to a trigger on a target component button.

Optionally, the block identifier obtaining module comprises: a type identifier obtaining module configured to obtain a type identifier corresponding to the target component in response to a trigger on a target component button; a setting parameter obtaining module configured to display a first interface based on the type identifier, and obtain a setting parameter input through the first interface; a request module configured to send a service instance creation request to a service side, the service instance creation request comprising the setting parameter to enable the service side to send a block creation request to the target platform, and the block creation request comprising the type identifier and the setting parameter to enable the target platform to generate the block information entity and establish a correspondence relationship between the block information entity and the block identifier; and a block identifier receiving module configured to receive the block identifier sent by the service side, the block identifier of the service side being from the target platform.

Optionally, the block identifier obtaining module further comprises in response to a trigger operation performed by a user on the document, displaying a list of components, the list of components comprising the target component button.

Optionally, the block identifier obtaining module further comprises an available component display module configured to obtain an available component corresponding to the user based on a permission of the user in response to the trigger operation performed by the user on the document, and display the list of components, the list of components comprising the available component corresponding to the user.

FIG. 20 is a schematic diagram of a structure of a further apparatus for processing a component provided in embodiments of the present disclosure. As shown in FIG. 20, the apparatus for processing a component comprises: a component panel display module 001 configured to display a component panel in response to receiving a trigger operation on a first target control in a document page, the component panel comprising at least one target component, and the first target control having a one-to-one correspondence with a content line in the document page; and a component content display module 002 configured to display component content corresponding to the target component in a content line associated with the first target control in the document page in response to a selection operation on the target component.

Optionally, the apparatus further comprises a first target component display module configured to display the first target control at a position associated with the empty content line in response to a focus selection of an empty content line in the document page.

Optionally, the apparatus further comprises a second target control display module configured to display a second target control at a position associated with the non-empty content line in response to a focus selection of a non-empty content line in the document page, the second target control being used to edit content in the content line.

Optionally, the apparatus further comprises the component content display unit configured to display the component content corresponding to the target component in a line adjacent to the content line corresponding to the first target control; or display the component content corresponding to the target component in the content line corresponding to the first target control

Optionally, the apparatus further comprises an expanded component content display unit configured to expand a range of the content line corresponding to the first target control, and displaying the component content corresponding to the target component in the expanded content line.

Optionally, the apparatus further comprises a component block generation block configured to associate the component content corresponding to the target component with the content line to generate a component block, the component block being editable as a whole.

It is noted that the embodiment of the above-described apparatus, the various units and blocks included are only divided according to functional logic, but is not limited to the above division, as long as the corresponding function can be achieved; further, the specific names of the functional units are only for ease of distinction from each other, and are not intended to limit the scope of the present invention.

Apparatus provided in the embodiment of the present application may perform the method provided in any embodiment of the present application, and having the corresponding functional modules for performing the method and beneficial effects.

FIG. 21 is a schematic diagram of a structure of an electronic device provided in embodiments of the present disclosure of the disclosure. As shown in FIG. 21, the electronic device includes a processor 810, a memory 820, an input device 830 and an output device 840. The number of processors 810 in the electronic device can be one or more, and one processor 810 is taken as an example in FIG. 21. The processor 810, memory 820, input device 830 and output device 840 in the electronic device can be connected via a bus or other means, and the connection via a bus is taken as an example in FIG. 21.

The memory 820 may be used as a computer-readable storage medium to store software programs, computer-executable programs and blocks, such as program instructions/blocks corresponding to the method for recommending an object in the embodiments of the present invention. The processor 810 executes various functional applications and data processing of the electronic device by running software programs, instructions, and modules stored in the memory 820, which implement the method provided in the embodiments of the present invention.

The memory 820 may include primarily a program store block, which may store an operating system, an application program required for at least one function, and a data store block, which may store data created based on the use of an terminal, etc. In addition, the memory 820 may include high-speed random access memory, and may also include non-volatile memory, such as at least one disk storage device, flash memory device, or other non-volatile solid-state storage device. In some examples, the memory 820 may further include memory remotely provided relative to the processor 810, which may be connected to a computer device via a network. Examples of the above networks include, but are not limited to, the Internet, an intranet, a local area network, a mobile communication network, and combinations thereof.

The input device 830 can be used to receive input digital or character information, and generate key signal inputs related to user settings and function control of electronic devices, including keyboards, mice, etc. The output device 840 can include display devices such as displays.

The embodiments of the present disclosure also provide a storage medium comprising computer-executable instructions, and the computer-executable instructions, when executed by a computer processor, implements the method provided in the embodiments of the present disclosure.

The storage medium provided in the embodiments of the present invention comprises computer-executable instructions which are not limited to the method operations described above and may also be performed the relevant operations of the method provided in any embodiment of the present invention undoubtedly.

The present disclosure provides a further computer program product, and the computer program product, when run on a computer, causes the computer to execute the method of the above embodiments.

It should be noted that in this article, relational terms such as “first” and “second” are only used to distinguish one entity or operation from a further entity or operation, and do not necessarily require or imply any actual relationship or order between these entities or operations. Moreover, the terms “including”, “comprising”, or any other variant thereof are intended to cover non-exclusive inclusion, so that a process, method, article, or device that includes a series of elements not only includes those elements, but also includes other elements not explicitly listed, or includes elements inherent to such a process, method, article, or device. Without further restrictions, an element defined by the phrase “including a . . . ” does not exclude the existence of additional identical elements in the process, method, article, or device that includes the element.

The foregoing is merely a detailed description of the disclosure to enable those skilled in the art to understand or implement the disclosure. Various modifications to these embodiments will be apparent to those skilled in the art, and the general principles defined herein may be implemented in other embodiments without departing from the spirit or scope of the disclosure. Accordingly, the disclosure will not be limited to the embodiments described herein, but will be subject to the widest scope consistent with the principles and novel features disclosed herein.

1. A method for processing a component, comprising:
sending a block information entity request to a target platform, the block information entity request comprising a block identifier corresponding to a target component;
receiving a block information entity corresponding to the target component sent by the target platform; and
invoking a component software development kit to render the target component in a document based on the block information entity.

2. The method of claim 1, wherein before the sending a block information entity request to a target platform, the method further comprises:
in response to a trigger on a target component button, obtaining the block identifier corresponding to the target component.

3. The method of claim 2, wherein in response to a trigger on a target component button, the obtaining the block identifier corresponding to the target component comprises:
in response to a trigger on a target component button, obtaining a type identifier corresponding to the target component;
displaying a first interface based on the type identifier, and obtaining a setting parameter input through the first interface;
sending a service instance creation request to a service side, the service instance creation request comprising the setting parameter to enable the service side to send a block creation request to the target platform, and the block creation request comprising the type identifier and the setting parameter to enable the target platform to generate the block information entity and establish a correspondence relationship between the block information entity and the block identifier; and
receiving the block identifier sent by the service side, the block identifier of the service side being from the target platform.

4. The method of claim 2, wherein before the response to a trigger on a target component button, the method further comprises:
in response to a trigger operation performed by a user on the document, displaying a list of components, the list of components comprising the target component button.

5. The method of claim 4, wherein in response to a trigger operation performed by a user on the document, the displaying a list of components comprises:
in response to the trigger operation performed by the user on the document, obtaining an available component corresponding to the user based on a permission of the user.

6. The method of claim 1, further comprising:
setting a host of the target component as the document.

7. A method for processing a component, characterized in comprising:
in response to receiving a trigger operation on a first target control in a document page, displaying a component panel, the component panel comprising at least one target component, and the first target control having a one-to-one correspondence with a content line in the document page; and
in response to a selection operation on the target component, displaying component content corresponding to the target component in a content line associated with the first target control in the document page.

8. The method of claim 7, further comprising:
in response to a focus selection of an empty content line in the document page, displaying the first target control at a position associated with the empty content line.

9. The method of claim 7, further comprising:
in response to a focus selection of a non-empty content line in the document page, displaying a second target control at a position associated with the non-empty content line, the second target control being used to edit content in the content line.

10. The method of claim 7, wherein the displaying component content corresponding to the target component in a content line associated with the first target control in the document page comprises:
displaying the component content corresponding to the target component in a line adjacent to the content line corresponding to the first target control; or
displaying the component content corresponding to the target component in the content line corresponding to the first target control.

11. The method of claim 7, wherein the displaying component content corresponding to the target component in a content line associated with the first target control in the document page comprises:
expanding a range of the content line corresponding to the first target control, and displaying the component content corresponding to the target component in the expanded content line.

12. The method of claim 7, wherein the displaying component content corresponding to the target component in a content line associated with the first target control in the document page comprises:
associating the component content corresponding to the target component with the content line to generate a component block, the component block being editable as a whole.

13-14. (canceled)

15. An electronic device, comprising:
one or more processors; and
a storage device for storing one or more programs which, when executed by the one or more processors, cause the one or more processors to perform acts comprising:
sending a block information entity request to a target platform, the block information entity request comprising a block identifier corresponding to a target component;
receiving a block information entity corresponding to the target component sent by the target platform; and
invoking a component software development kit to render the target component in a document based on the block information entity.

16-17. (canceled)

18. The electronic device of claim 15, wherein before the sending a block information entity request to a target platform, the acts further comprise:
in response to a trigger on a target component button, obtaining the block identifier corresponding to the target component.

19. The electronic device of claim 18, wherein in response to a trigger on a target component button, the obtaining the block identifier corresponding to the target component comprises:
in response to a trigger on a target component button, obtaining a type identifier corresponding to the target component;
displaying a first interface based on the type identifier, and obtaining a setting parameter input through the first interface;
sending a service instance creation request to a service side, the service instance creation request comprising the setting parameter to enable the service side to send a block creation request to the target platform, and the block creation request comprising the type identifier and the setting parameter to enable the target platform to generate the block information entity and establish a correspondence relationship between the block information entity and the block identifier; and
receiving the block identifier sent by the service side, the block identifier of the service side being from the target platform.

20. The electronic device of claim 18, wherein before the response to a trigger on a target component button, the acts further comprise:
in response to a trigger operation performed by a user on the document, displaying a list of components, the list of components comprising the target component button.

21. The electronic device of claim 20, wherein in response to a trigger operation performed by a user on the document, the displaying a list of components comprises:
in response to the trigger operation performed by the user on the document, obtaining an available component corresponding to the user based on a permission of the user.

22. The electronic device of claim 15, further comprising:
setting a host of the target component as the document.

23. The electronic device of claim 15, wherein the target component is one or more of an instant messaging communication component, a timer, a workbench, or a calendar.

24. The method of claim 1, wherein the target component is one or more of an instant messaging communication component, a timer, a workbench, or a calendar.
